(19) United States
(12) Patent Application Publication
(10) Pub. No.: US 2026/0333090 A1
(43) Pub. Date: Oct. 22, 2026

(54) COMMUNICATION APPARATUS, BASE STATION, AND COMMUNICATION METHOD

(71) Applicant: DENSO CORPORATION, Kariya-city (JP)

(72) Inventor: Tatsuki NAGANO, Kariya-city (JP)

(21) Appl. No.: 19/529,382

(22) Filed: Feb. 4, 2026

Related U.S. Application Data
(63) Continuation of application No. PCT/JP2024/027275, filed on Jul. 31, 2024.

(30) Foreign Application Priority Data
Aug. 9, 2023 (JP) 2023-130198

(51) Int. Cl. H04W 24/08; H04W 72/1263; H04W 72/232

(52) U.S. Cl. CPC H04W 24/08; H04W 72/1263; H04W 72/232

(57) ABSTRACT

A communication apparatus receives a RRC message including: measurement gap configuration information including first information for configuring a duration of a measurement gap; information indicating that second information is included in DCI format 1_1, the second information being for determining whether transmission and/or reception is enabled during the duration of the measurement gap; and information indicating that the second information is included in DCI format 0_1. The communication apparatus: determines, based on the information indicating that the second information is included in the DCI format 1_1 being included in the RRC message, which of the measurement and transmission and/or reception is enabled, in accordance with the second information; and determines, based on the information indicating that the second information is included in the DCI format 0_1 being included in the RRC message, which of the measurement and transmission and/or reception is enabled, in accordance with the second information.

### CROSS-REFERENCE TO RELATED APPLICATION

The present application is a continuation application of international Patent Application No. PCT/JP2024/027275, filed on Jul. 31, 2024, which designated the U.S., and claims the benefit of priority of Japanese Patent Application No. 2023-130198, filed on Aug. 9, 2023, the entire contents of which are incorporated herein by reference.

### TECHNICAL FIELD

The present disclosure relates to a communication apparatus and a communication method.

### BACKGROUND ART

In the 3rd Generation Partnership Project (3GPP (registered trademark; the same applies hereinafter)), which is a mobile communication system standardization project, an extended reality (XR) service is scheduled to be introduced.

As one of the traffic characteristics of the XR service, a traffic period of XR data is defined by a non-integer value (for example, 60 fps (=16.67 ms) or 120 fps (=8.33 ms)). On the other hand, the period of a measurement duration that is configured for a communication apparatus to measure the radio quality of a cell is configured by using an integer value (for example, 20 ms). Therefore, there is a possibility that a duration for which a network desires to schedule XR data will collide with the measurement duration. For the measurement duration, the communication apparatus performs measurement, and therefore communication between the communication apparatus and a base station (a serving cell) is not assumed, and scheduling is restricted. For this reason, there is a concern that the network fails to schedule XR data having very severe delay requirements in a timely manner, and communication capacity is reduced.

In view of this, it has been proposed that the base station instructs a UE to prioritize decoding of a physical downlink control channel (PDCCH)/physical downlink shared channel (PDSCH) for a duration of a synchronization signal (SS)/physical broadcast channel (PBCH) (SS/PBCH) block measurement timing configuration (SMTC) window (see, for example, Non Patent Literature 1).

### CITATION LIST

### Non Patent Literature

Non Patent Literature 1:3GPP Contribution “R1-2206226_9.11.2_Capacity_enhancements”

### SUMMARY OF INVENTION

A communication apparatus according to a first aspect comprises: a receiver configured to receive a radio resource control (RRC) message; and a controller. The RRC message includes: measurement gap configuration information including first information for configuring a duration of a measurement gap for measurement of radio quality; information indicating that second information is included in downlink control information (DCI) format 1_1, the second information being for determining whether at least one of transmission and reception is enabled during the duration of the measurement gap; and information indicating that the second information is included in DCI format 0_1. The controller is configured to: determine, based on the information indicating that the second information is included in the DCI format 1_1 being included in the RRC message, which of the measurement of radio quality during the duration of the measurement gap and at least one of transmission and reception during the duration of the measurement gap is enabled, in accordance with the second information included in the DCI format 1_1; and determine, based on the information indicating that the second information is included in the DCI format 0_1 being included in the RRC message, which of the measurement of radio quality during the duration of the measurement gap and at least one of transmission and reception during the duration of the measurement gap is enabled, in accordance with the second information included in the DCI format 0_1.

A base station according to a second aspect comprises: a transmitter configured to transmit a radio resource control (RRC) message to a communication apparatus. The RRC message includes: measurement gap configuration information including first information for configuring a duration of a measurement gap for measurement of radio quality; information indicating that second information is included in downlink control information (DCI) format 1_1, the second information used by the communication apparatus to determine whether at least one of transmission and reception is enabled during the duration of the measurement gap; and information indicating that the second information is included in DCI format 0_1. The transmitter is configured to:
transmit, to the communication apparatus, the DCI format 1_1 including the second information based on transmitting the RRC message including the information indicating that the second information is included in the DCI format 1_1; and
transmit, to the communication apparatus, the DCI format 0_1 including the second information based on transmitting the RRC message including the information indicating that the second information is included in the DCI format 0_1.

A communication method according to a third aspect is a communication method performed by a communication apparatus. The communication method comprises receiving a radio resource control (RRC) message including: measurement gap configuration information including first information for configuring a duration of a measurement gap for measurement of radio quality; information indicating that second information is included in downlink control information (DCI) format 1_1, the second information being for determining whether at least one of transmission and reception is enabled during the duration of the measurement gap; and information indicating that the second information is included in DCI format 0_1, and determining, based on the information indicating that the second information is included in the DCI format 1_1 being included in the RRC message, which of the measurement of radio quality during the duration of the measurement gap and at least one of transmission and reception during the duration of the measurement gap is enabled, in accordance with the second information included in the DCI format 1_1; and determining, based on the information indicating that the second information is included in the DCI format 0_1 being included in the RRC message, which of the measurement of radio quality during the duration of the measurement gap and at least one of transmission and reception during the duration of the measurement gap is enabled, in accordance with the second information included in the DCI format 0_1.

### BRIEF DESCRIPTION OF DRAWINGS

Objects, features, advantages, and the like of the present disclosure will become more apparent from the following detailed description with reference to the accompanying drawings.

FIG. 1 is a diagram illustrating a configuration of a mobile communication system according to an embodiment.

FIG. 2 is a diagram illustrating a configuration example of a protocol stack according to the embodiment.

FIG. 3 is a diagram illustrating a configuration of a UE according to the embodiment.

FIG. 4 is a diagram illustrating a configuration of a base station according to the embodiment.

FIG. 5 is a sequence diagram for explaining a first operation example according to the embodiment.

FIG. 6 is a flowchart (no. 1) for explaining the first operation example according to the embodiment.

FIG. 7 is a flowchart (no. 2) for explaining the first operation example according to the embodiment.

FIG. 8 is a flowchart (no. 3) for explaining the first operation example according to the embodiment.

FIG. 9 is a flowchart (no. 4) for explaining the first operation example according to the embodiment.

FIG. 10 is a flowchart (no. 5) for explaining the first operation example according to the embodiment.

FIG. 11 is a flowchart (no. 6) for explaining the first operation example according to the embodiment.

FIG. 12 is a sequence diagram for explaining a second operation example according to the embodiment.

FIG. 13 is a flowchart for explaining the second operation example according to the embodiment.

### DESCRIPTION OF EMBODIMENTS

However, currently, a specific method of prioritizing communication between the communication apparatus and the base station over measurement for the measurement duration has not been specified. Therefore, there is a concern that the communication apparatus fails to appropriately determine which of communication with the base station and measurement is to be prioritized for the measurement duration, and the communication apparatus fails to appropriately prioritize the communication over the measurement for the measurement duration.

In view of this, an object of the present disclosure is to provide a communication apparatus, a base station, and a communication method that are capable of appropriately prioritizing communication between the communication apparatus and the base station over measurement of the radio quality of a cell for a measurement duration for measuring the radio quality.

A mobile communication system according to an embodiment will be described with reference to the drawings. In the description of the drawings, the same or similar portions are denoted by the same or similar reference numerals.

### System Configuration

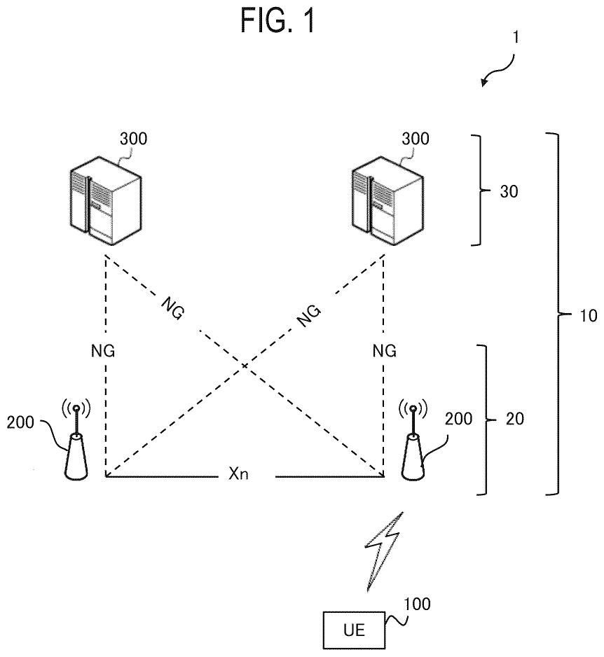

First, a configuration of a mobile communication system 1 according to the present embodiment will be described with reference to FIG. 1. The mobile communication system 1 is, for example, a system conforming to the 3GPP technical specification (TS). Hereinafter, description will be provided by using a 5th generation system (a 5G system) of the 3GPP standard, that is, a mobile communication system based on new radio (NR) radio access, as an example of the mobile communication system 1.

The mobile communication system 1 includes a network 10, and a user equipment (UE) 100 that communicates with the network 10. The network 10 includes a next generation radio access network (NG-RAN) 20, which is a 5G radio access network, and a 5G core network (5GC) 30, which is a core network of 5G.

The UE 100 is a communication apparatus that communicates via a base station 200. The UE 100 may be an apparatus that is used by a user. The UE 100 is, for example, a mobile apparatus such as a mobile phone terminal, e.g., a smartphone, a tablet terminal, a laptop PC, a communication module, or a communication card. The UE 100 may be a vehicle (for example, a car or a train) or an apparatus provided in the vehicle. The UE 100 may be a transport body other than the vehicle (for example, a ship or an airplane) or an apparatus provided in the transport body. The UE 100 may be a sensor or an apparatus provided in the sensor. Note that the UE 100 may be called by another term such as a terminal, a terminal apparatus, a mobile station, a mobile terminal, a mobile apparatus, a mobile unit, a subscriber station, a subscriber terminal, a subscriber apparatus, a subscriber unit, a wireless station, a wireless terminal, a wireless apparatus, a wireless unit, a remote station, a remote terminal, a remote apparatus, or a remote unit. Furthermore, the UE 100 is an example of a terminal, and the terminal may include a factory device or the like.

The NG-RAN 20 includes a plurality of base stations 200. Each of the base stations 200 manages at least one cell. The cell forms a minimum unit of a communication area. One cell belongs to one frequency (a carrier frequency). The term “cell” indicates a radio communication resource in some cases, and indicates a communication object of the UE 100 in other cases. Each of the base stations 200 can perform radio communication with the UE 100 that presents in the local cell. The base station 200 communicates with the UE 100 by using a protocol stack of a RAN. Details of the protocol stack will be described later. Furthermore, one base station 200 is connected to another base station 200 (may be referred to as a neighboring base station) via an Xn interface. The base station 200 communicates with the neighboring base station via the Xn interface. Furthermore, the base station 200 provides NR user plane and control plane protocol terminations toward the UE 100, and is connected to the 5GC 30 via an NG interface. Such a base station 200 of NR is referred to as gNodeB (gNB) in some cases.

The 5GC 30 includes a core network apparatus 300. The core network apparatus 300 includes, for example, an access and mobility management function (AMF) and/or a user plane function (UPF). The AMF performs mobility management on the UE 100. The UPF provides a feature specialized for U-plane processing. The AMF and the UPF are connected to the base station 200 via the NG interface.

### Configuration Example of Protocol Stack

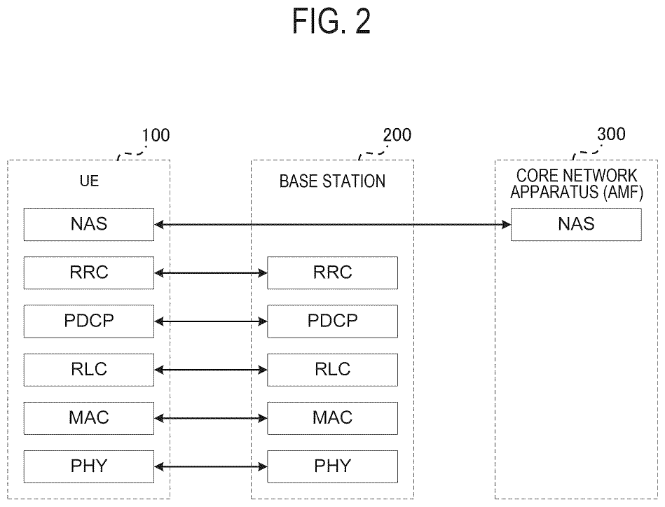

Next, a configuration example of a protocol stack according to the present embodiment will be described with reference to FIG. 2.

A protocol of a radio section between the UE 100 and the base station 200 includes a physical (PHY) layer, a medium access control (MAC) layer, a radio link control (RLC) layer, a packet data convergence protocol (PDCP) layer, and a radio resource control (RRC) layer.

The PHY layer performs coding and decoding, modulation and demodulation, antenna mapping and demapping, and resource mapping and demapping. Data and control information are transmitted between the PHY layer of the UE 100 and the PHY layer of the base station 200 via a physical channel.

The MAC layer performs data priority control, retransmission processing by using hybrid ARQ (HARQ), a random access procedure, and the like. Data and control information are transmitted between the MAC layer of the UE 100 and the MAC layer of the base station 200 via a transport channel. The MAC layer of the base station 200 includes a scheduler. The scheduler determines uplink and downlink transport formats (transport block size, modulation and coding scheme (MCS)) and resources to be allocated to the UE 100.

The RLC layer transmits data to the RLC layer on a reception side by using the features of the MAC layer and the PHY layer. Data and control information are transmitted between the RLC layer of the UE 100 and the RLC layer of the base station 200 via a logical channel.

The PDCP layer performs header compression and decompression, and encryption and decryption.

A service data adaptation protocol (SDAP) layer may be provided as an upper layer of the PDCP layer. The service data adaptation protocol (SDAP) layer performs mapping between an IP flow serving as a unit in which a core network performs quality of service (QoS) control and a radio bearer serving as a unit in which an access stratum (AS) performs QoS control.

The RRC layer controls the logical channel, the transport channel, and the physical channel in response to establishment, reestablishment, and release of the radio bearer. RRC signaling for various configurations is transmitted between the RRC layer of the UE 100 and the RRC layer of the base station 200. In a case where there is an RRC connection between the RRC of the UE 100 and the RRC of the base station 200, the UE 100 is in an RRC connected state. In a case where there is no RRC connection between the RRC of the UE 100 and the RRC of the base station 200, the UE 100 is in an RRC idle state. In a case where an RRC connection between the RRC of the UE 100 and the RRC of the base station 200 has been suspended, the UE 100 is in an RRC inactive state.

A NAS layer located above the RRC layer in the UE 100 performs session management and mobility management on the UE 100. NAS signaling is transmitted between the NAS layer of the UE 100 and a NAS layer of the core network apparatus 300.

Note that the UE 100 includes an application layer or the like in addition to a protocol of a radio interface.

### Radio Frame Configuration

In the 5G system, downlink transmission and uplink transmission are configured in a radio frame of 10 ms duration. For example, the radio frame is expressed by a system frame number (SFN) of 0 to 1023. For example, the radio frame includes 10 subframes. For example, one subframe may be 1 ms. Furthermore, one subframe may include one or more slots. For example, the number of symbols constituting one slot is 14 for a normal cyclic prefix (CP), and is 12 for an extended CP. In addition, the number of slots constituting one subframe changes depending on a configured subcarrier spacing. For example, in a case where the subcarrier spacing has been configured to be 15 kHz for the normal CP, the number of slots per subframe is one (that is, 14 symbols). In a case where the subcarrier spacing has been configured to be 30 kHz, the number of slots per subframe is two (that is, 28 symbols). In a case where the subcarrier spacing has been configured to be 60 kHz, the number of slots per subframe is four (that is, 56 symbols). In a case where the subcarrier spacing has been configured to be 120 kHz, the number of slots per subframe is eight (that is, 128 symbols). In a case where the subcarrier spacing has been configured to be 60 kHz for the extended CP, the number of slots per subframe is four (that is, 48 symbols). Stated another way, the number of slots constituting one subframe is determined on the basis of the subcarrier spacing configured by the base station 200. In addition, the number of symbols constituting one subframe is determined on the basis of the subcarrier spacing configured by the base station 200. Stated another way, the number of symbols constituting a subframe of 1 ms is determined on the basis of the subcarrier spacing configured by the base station 200, and the length (the length in a time direction) of each symbol changes.

### outline of Feature of Measurement of Received Quality of Local Cell/Another Cell

In order to appropriately perform handover to another cell or carrier aggregation (CA), the UE 100 can measure the radio quality (received quality) of a cell by using, for example, reference signal received power (RSRP) and/or reference signal received quality (RSRQ). The radio quality is measured on the basis of, for example, a synchronization signal (SS) and physical broadcast channel (PBCH) block (SSB), and a channel state information reference signal (CSI-RS).

The network 10 can configure, for example, a measurement duration and a measurement timing of the SSB for the UE 100, by using SS/PBCH block (SSB) measurement timing configuration (SMTC). In order to control SMTC, the network 10 can configure, for the UE 100, a parameter such as a duration (for example, duration) of a measurement window for receiving the SSB, or a period and an offset (for example, periodicityAndOffset) of the measurement window, by using an RRC message (for example, measurement configuration information (for example, MeasConfig)). For example, a first subframe of each SMTC occurs in a system frame number (SFN) and a subframe of a cell (for example, NR SpCell) that fulfills designated conditions. Note that a transmission period of the SSB can be configured for each cell by using SIB1. In order to reduce power consumption, a measurement duration of the SSB that is configured for the UE 100 does not need to be the same as a transmission period of the SSB.

Here, scheduling restriction may be applied to the UE 100 for a duration for which there is a possibility that measurement will be performed according to the SMTC. For example, scheduling restriction may be applied in the L1-RSRP measurement in frequency range 2 (FR2). In this case, it is not assumed that the UE 100 transmits a physical uplink control channel (PUCCH)/physical uplink shared channel (PUSCH)/sounding reference signal (SRS) and/or receives a physical downlink control channel (PDCCH)/physical downlink shared channel (PDSCH)/CSI-RS for tracking/CSI-RS for a channel quality indicator (CQI) in a symbol that corresponds to SSB/CSI-RS configured for L1-RSRP measurement.

### Outline of Measurement Gap

A measurement gap (MG) is configured, for example, when the UE 100 in the RRC connected state desires to measure the received quality of another cell by using a shared radio frequency (RF) apparatus. For example, within a duration configured as the measurement gap, the UE 100 can perform measurement on a cell having a frequency different from that of a serving cell (that is, inter-frequency measurement). Note that, within the duration configured as the measurement gap, the UE 100 can also perform measurement on a cell having a frequency that is the same as that of the serving cell (that is, intra-frequency measurement).

In order to control the measurement gap, the network 10 can configure, for the UE 100, a parameter such as a gap offset (for example, gapOffset), a measurement gap length (mgl), a measurement gap repetition period (mgrp), or measurement gap timing advance (mgta) by using an RRC message (for example, measurement configuration information (for example, MeasConfig)). The parameter can be configured for each frequency range 1 (FR1)/frequency range 2 (FR2) or for each of the UEs 100.

A first subframe of each of the measurement gaps occurs in an SFN and a subframe that fulfill designated conditions. The measurement gap timing advance is applied to a calculated measurement gap. Therefore, the UE 100 initiates measurement before the subframe that fulfills the designated conditions by the measurement gap timing advance.

Note that for the duration configured as the measurement gap, data transmission and reception between the UE 100 and the serving cell stops, and thus throughput decreases.

### Assumed Scenario

In the 3rd Generation Partnership Project (3GPP (registered trademark; the same applies hereinafter)), which is a mobile communication system standardization project, an extended reality (XR) service is scheduled to be introduced. Characteristics of the XR traffic (the XR service) include, for example, a non-integer period such as 60 or 120 fps (16.67 or 8.33 ms), variation jitter in an arrival timing of traffic due to encoding or an NW transmission delay, and a plurality of data streams having different traffic characteristics or QoS requirements (a plurality of flows (multiple flows); for example, an I frame and a P frame, or a video and sound/data).

As one of the traffic characteristics of the XR service, a traffic period of XR data is defined by a non-integer value (for example, 60 fps (=16.67 ms) or 120 fps (=8.33 ms)). On the other hand, the period of a measurement duration (for example, a period of a SMTC window or a period of the measurement gap) that is configured for the UE 100 to measure the radio quality of a cell is configured by using an integer value (for example, 20 ms). Therefore, there is a possibility that a duration for which the network 10 desires to schedule XR data will collide with the measurement duration. For the measurement duration, the UE 100 performs measurement, and therefore communication between the UE 100 and the base station 200 (the serving cell) is not assumed, and scheduling is restricted. For this reason, there is a concern that the network 10 fails to schedule XR data having very severe delay requirements in a timely manner, and communication capacity decreases. In view of this, it has been proposed that the base station 200 instructs the UE to prioritize decoding of a PDCCH/PDSCH for a duration of the SMTC window.

However, currently, a specific method of prioritizing communication between the UE 100 and the base station 200 over measurement for the measurement duration has not been specified. Therefore, there is a concern that the UE 100 fails to appropriately determine which of communication with the base station 200 and measurement is to be prioritized for the measurement duration, and the UE 100 fails to appropriately prioritize the communication over the measurement for the measurement duration. In an embodiment to be described later, an operation to enable communication between the UE 100 and the base station 200 to be appropriately prioritized over measurement of the radio quality of a cell for a measurement duration for measuring the radio quality will be described.

### Configuration of UE 100

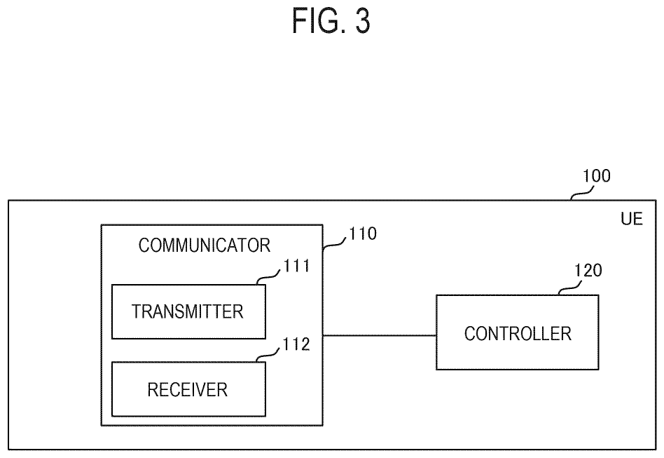

A configuration of the UE 100 according to the embodiment will be described with reference to FIG. 3. The UE 100 includes a communicator 110 and a controller 120.

The communicator 110 performs radio communication with the base station 200 by transmitting and receiving a radio signal to and from the base station 200. The communicator 110 includes at least one transmitter 111 and at least one receiver 112. The transmitter 111 and the receiver 112 may include a plurality of antennas and a radio frequency (RF) circuit. The antenna converts a signal into a radio wave and emits the radio wave into a space. Furthermore, the antenna receives a radio wave in a space, and converts the radio wave into a signal. The RF circuit performs analog processing on a signal transmitted and received via the antenna. The RF circuit may include a radio frequency filter, an amplifier, a modulator, a low pass filter, and the like.

The controller 120 performs various types of control in the UE 100. The controller 120 controls communication with the base station 200 via the communicator 110. The operations described above and described below of the UE 100 may be operations under the control of the controller 120. The controller 120 may include at least one processor that is capable of executing a program, and a memory that stores the program. The processor may execute the program to perform the operation of the controller 120. The controller 120 may include a digital signal processor that performs digital processing on a signal transmitted and received via the antenna and the RF circuit. The digital processing includes processing of the protocol stack of the RAN. Note that the memory stores the program to be executed by the processor, parameters relating to the program, and data relating to the program. The memory may include at least one of a read only memory (ROM), an erasable programmable read only memory (EPROM), an electrically erasable programmable read only memory (EEPROM), a random access memory (RAM), and a flash memory. The entirety or part of the memory may be included in the processor.

In the UE 100 configured as described above, the receiver 112 may receive, from the base station 200, priority information relating to whether to prioritize communication between the UE 100 and the base station 200 for a measurement duration serving as a duration for which radio quality is measured. The controller 120 may determine whether to prioritize communication over measurement for the measurement duration, on the basis of the priority information. The priority information may be configured for at least any of the measurement duration, scheduling configuration for allocating a radio resource for communication in advance, and discontinuous reception (DRX). The controller 120 may perform determination on an object for which the priority information has been configured. As a result, the UE 100 clearly grasps an object on which determination is to be performed on the basis of the priority information. The UE 100 can appropriately determine communication to be prioritized for the measurement duration, by performing priority determination on the object. As a result, communication with the base station 200 can be appropriately prioritized over measurement for the measurement duration.

Furthermore, in the UE 100, the receiver 112 may receive, from the base station 200, priority information relating to whether to prioritize SR transmission from the UE 100 to the base station 200 over measurement for the measurement duration. The controller 120 may determine whether to prioritize SR transmission over measurement for the measurement duration, on the basis of the priority information. As a result, the controller 120 can appropriately determine whether to prioritize SR transmission, and can appropriately perform priority determination.

In addition, the receiver 112 of the UE 100 receives, from the base station 200, DCI including the priority information relating to whether to prioritize communication between the UE 100 and the base station 200 for the measurement duration. The controller 120 determines whether to prioritize communication over measurement for the measurement duration, on the basis of the priority information. As a result, the network 10 can notify a dynamic UE 100 of the priority information in comparison with a case where the priority information is transmitted by using the RRC message. The network 10 can easily schedule XR data in a timely manner, by transmitting the DCI including the priority information, for example, in a case where the traffic of the XR data arrives within the measurement duration. As a result, communication capacity can be prevented from decreasing.

### Configuration of Base Station

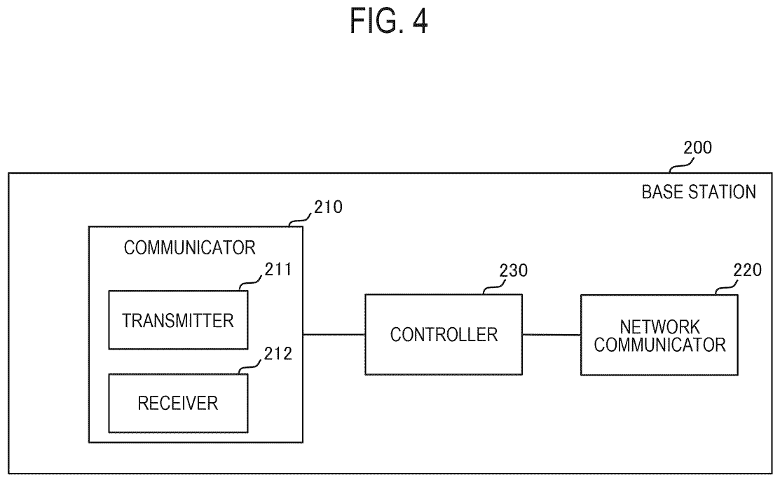

A configuration of the base station 200 according to the embodiment will be described with reference to FIG. 4. The base station 200 includes a communicator 210, a network communicator 220, and a controller 230.

For example, the communicator 210 receives a radio signal from the UE 100, and transmits a radio signal to the UE 100. The communicator 210 includes at least one transmitter 211 and at least one receiver 212. The transmitter 211 and the receiver 212 may include an RF circuit. The RF circuit performs analog processing on a signal transmitted and received via the antenna. The RF circuit may include a radio frequency filter, an amplifier, a modulator, a low pass filter, and the like.

The network communicator 220 transmits and receives a signal to and from a network. For example, the network communicator 220 receives a signal from a neighboring base station that is connected via the Xn interface serving as an interface between base stations, and transmits a signal to the neighboring base station. As another example, the network communicator 220 receives a signal from the core network apparatus 300 that is connected via the NG interface, and transmits a signal to the core network apparatus 300.

The controller 230 performs various types of control in the base station 200. The controller 230 controls, for example, communication with the UE 100 via the communicator 210. The controller 230 also controls, for example, communication with a node (for example, a neighboring base station or the core network apparatus 300) via the network communicator 220. The operations described above and described below of the base station 200 may be operations under the control of the controller 230. The controller 230 may include at least one processor that is capable of executing a program, and a memory that stores the program. The processor may execute the program to perform the operation of the controller 230. The controller 230 may include a digital signal processor that performs digital processing on a signal transmitted and received via the antenna and the RF circuit. The digital processing includes processing of the protocol stack of the RAN. Note that the memory stores the program to be executed by the processor, parameters relating to the program, and data relating to the program. The entirety or part of the memory may be included in the processor.

### First Operation Example

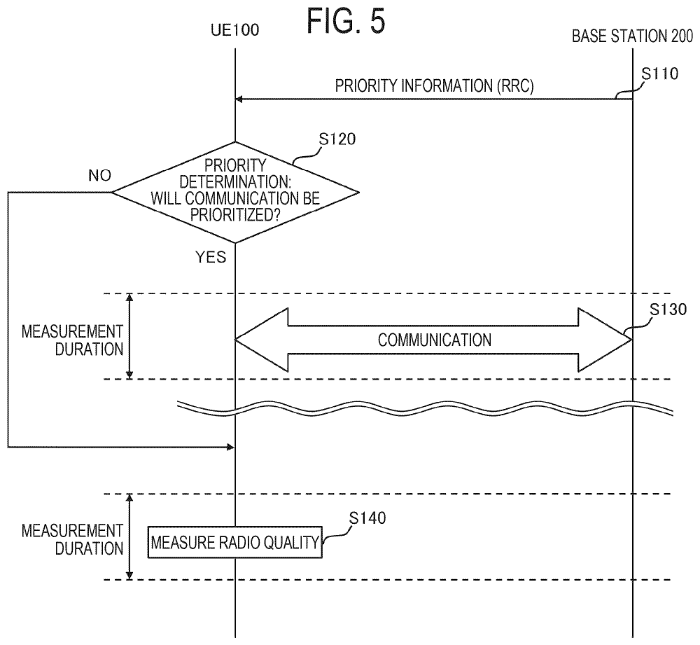

A first operation example will be described with reference to FIGS. 5 to 11. An already provided description is omitted in some cases. In the present operation example, the UE 100 is in an RRC connected state with a cell (a serving cell) managed by the base station 200.

### (A1) Outline of First Operation Example

### Step S110

The transmitter 211 of the base station 200 transmits, to the UE 100, priority information relating to whether to prioritize communication between the UE 100 and the base station 200 for a measurement duration serving as a duration for which radio quality is measured. The receiver 112 of the UE 100 receives the priority information from the base station 200. Details of the priority information will be described later.

The transmitter 211 of the base station 200 may transmit the priority information by using an RRC message. The controller 230 may include the priority information in designated configuration information included in the RRC message.

The controller 230 of the base station 200 may perform control to transmit the priority information in a case where the measurement duration is configured for the UE 100. The measurement duration may be, for example, a duration configured by using the SMTC or a duration configured as a measurement gap.

The controller 230 may configure the priority information for a designated object. The designated object may be, for example, at least any of the measurement duration, scheduling configuration for allocating a radio resource for communication in advance, and discontinuous reception (DRX). Therefore, the priority information may be configured for at least any of the measurement duration, the scheduling configuration, and the discontinuous reception.

### Step S120

The controller 120 of the UE 100 performs determination as to whether to prioritize communication with the base station 200 over measurement for the measurement duration (hereinafter, priority determination), on the basis of the priority information. Details of the priority determination will be described later.

In a case where the controller 230 has determined that communication with the base station 200 will be prioritized over measurement for the measurement duration, the controller 230 performs the process of step S130. On the other hand, in a case where the controller 230 has determined that communication with the base station 200 will not be prioritized over measurement for the measurement duration, that is, in a case where the controller 230 has determined that measurement will be prioritized over communication with the base station 200 for the measurement duration, the controller 230 performs the process of step S140.

### Step S130:

The controller 120 performs control to communicate with the base station 200 (specifically, the serving cell) for the measurement duration. Communication with the base station 200 may be, for example, at least any of the following.
Decode PDCCH
Decode PDSCH
Transmit PUCCH
Transmit PUSCH
Transmit scheduling request (SR)

The controller 120 may perform control to communicate with the base station 200 over the entire measurement duration. The controller 120 may perform control to communicate with the base station 200 for part of the measurement duration. For example, the controller 120 may perform control to only communicate with the base station 200 for a duration for which a duration allocated for communication with the base station 200 (hereinafter, a communication duration) overlaps the measurement duration. The controller 120 may perform control to measure the radio quality for a duration for which the communication duration does not overlap the measurement duration.

Note that (a length unit of) the communication duration may be at least any of SFN, a subframe, a slot, and/or a symbol.

### Step S140

The controller 120 performs control to measure the radio quality without communicating with the base station 200 for the measurement duration.

As described above, the receiver 112 of the UE 100 may receive, from the base station 200, priority information relating to whether to prioritize communication between the UE 100 and the base station 200 for a measurement duration serving as a duration for which the radio quality is measured. The controller 120 may determine whether to prioritize communication over measurement for the measurement duration, on the basis of the priority information. The priority information may be configured for at least any of the measurement duration, scheduling configuration for allocating a radio resource for communication in advance, and discontinuous reception (DRX). The controller 120 may perform determination on an object for which the priority information has been configured. As a result, the UE 100 clearly grasps an object on which determination is to be performed on the basis of the priority information. The UE 100 can appropriately determine communication to be prioritized for the measurement duration, by performing priority determination on the object. As a result, communication with the base station 200 can be appropriately prioritized over measurement for the measurement duration.

### (A2) Priority Determination

The controller 120 may perform priority determination by using at least any of the following methods. The controller 120 may perform determination on an object for which the priority information has been configured.

### (2-1) First Priority Determination

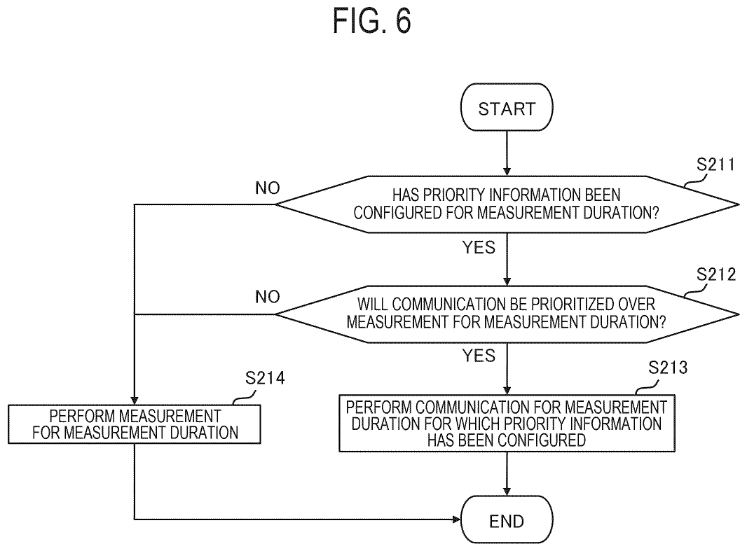

First priority determination will be described with reference to FIG. 6. In the first priority determination, the controller 120 of the UE 100 determines whether the priority information has been configured for the measurement duration.

### Step S211

The controller 120 determines whether the priority information has been configured for the measurement duration. In a case where the priority information has been configured for the measurement duration, the controller 120 performs the process of step S212. On the other hand, in a case where the priority information has not been configured for the measurement duration, the controller 120 performs the process of step S214.

For example, in a case where the priority information is included in configuration information for configuring the measurement duration for the UE 100, the controller 120 may determine that the priority information has been configured for the measurement duration. The configuration information may be measurement configuration information (for example, MeasConfig) that not only specifies measurement to be performed by the UE 100 and configures the measurement gap but also covers intra-frequency, inter-frequency, and inter-radio access technology (RAT) mobility.

For example, in a case where the priority information is included in measurement object information (for example, MeasObjectNR) that specifies information applicable to SSB intra-frequency/inter-frequency measurement and/or CSI-RS intra-/inter-frequency measurement, the controller 120 may determine that the priority information has been configured for a duration of the SMTC window. In addition, in a case where the priority information is included in measurement gap configuration information (for example, MeasGapConfig) that specifies a measurement gap configuration and controls setup/release of the measurement gap, the controller 120 may determine that the priority information has been configured for a duration of the measurement gap. In addition, in a case where the priority information is included in each gap configuration information (for example, GapConfig) that constitutes a list of measurement gap configurations to be added or modified (for example, gapToAddModList), the controller 120 may determine that the priority information has been configured for a duration of a measurement gap configured by using the gap configuration information. Furthermore, in a case where the priority information and the measurement gap configuration (information) are associated with each other by using a measurement gap identifier (for example, MeasGapId) used to identify a measurement gap configuration (for each UE or each FR), the controller 120 may determine that the priority information has been configured for a duration of a measurement gap configured by using the gap configuration information.

The priority information may be configured in common to all of the measurement durations configured for the UE 100. The priority information may be dedicatedly configured for each of the measurement durations. Therefore, the priority information may be configured for a specified measurement duration. Therefore, from among a plurality of measurement durations configured for the UE 100, the priority information may be configured for a specified measurement duration, and the priority information may not be configured for the remaining measurement durations. For example, information for configuring a specified measurement duration and the priority information may be associated with each other. The controller 120 may perform the process of step S212 on the specified measurement duration. The controller 120 may perform the process of step S214 on a duration other than the specified measurement duration.

### Step S212

The controller 120 performs priority determination on the measurement duration for which the priority information has been configured. The controller 120 determines whether to prioritize communication with the base station 200 over measurement for the measurement duration. In a case where the controller 120 has determined that communication with the base station 200 will be prioritized over measurement for the measurement duration, the controller 120 performs the process of step S213. On the other hand, in a case where the controller 120 has determined that communication with the base station 200 will not be prioritized over measurement for the measurement duration, that is, in a case where the controller 120 has determined that measurement will be prioritized over communication with the base station 200 for the measurement duration, the controller 120 performs the process of step S214.

The priority information may indicate that communication will be prioritized, by using a designated value (for example, 1), and may indicate that measurement will be prioritized, by using a value other than the designated value (for example, 0). Furthermore, the priority information may indicate that communication will be prioritized, for example, by its presence in a designated field included in the RRC message. Alternatively, the priority information may indicate that measurement will be prioritized, for example, by not presenting in the designated field. The designated field is a field to which the priority information is mapped.

The priority information may indicate whether to prioritize communication over measurement, by using priority. The priority information may be, for example, information indicating low priority/high priority with 0/1. The priority information may be information indicating the priority by using an integer value.

### Step S213 (Corresponding to Step 130)

The controller 120 performs control to perform communication for a measurement duration for which the priority information has been configured. Communication may be at least either decoding of PDCCH/PDSCH or transmission of PUCCH/PUSCH.

The controller 120 performs decoding of a PDSCH, for example, for a duration for which the PDSCH has been scheduled within the measurement duration. The controller 120 performs PDCCH monitoring for a duration for which it has been instructed that PDCCH monitoring be performed within the measurement duration. The controller 120 performs transmission of a PUSCH for a duration for which the PUSCH has been scheduled within the measurement duration. The controller 120 may perform measurement for a duration other than the duration for which the PDSCH/PUSCH has been scheduled and the duration for which it has been instructed that PDCCH monitoring be performed within the measurement duration. Alternatively, the controller 120 may not perform measurement even for the measurement duration.

Note that the duration for which it has been instructed that PDCCH monitoring be performed may be a duration for which one or more timers relating to DRX are running (for example, Active time). The timer relating to DRX may be, for example, at least any of a DRX on-duration timer (drx-onDurationTimer) used to measure a DRX ON duration, a DRX inactivity timer (drx-InactivityTimer) used to measure an active time, a timer (drx-RetransmissionTimerUL) used to measure a duration of a slot specified for uplink data retransmission processing, and a timer (drx-RetransmissionTimerDL) used to measure a duration of a slot specified for downlink data retransmission processing.

In a case where a scheduling request (SR) from the UE 100 to the base station 200 has been triggered within a measurement duration for which the priority information has been configured, the controller 120 may perform control to perform SR transmission even for the measurement duration. The controller 120 may perform control to perform SR transmission, by using a resource (for example, a PUCCH resource) allocated by downlink control information (DCI) decoded by performing PDCCH monitoring. The controller 120 may perform control to perform SR transmission, by using a resource (for example, a PUSCH resource) based on a scheduling configuration to be described later.

### Step S214 (Corresponding to Step 140)

The controller 120 performs control to measure the radio quality without communicating with the base station 200 for the measurement duration for which the priority information has not been configured.

As described above, in a case where the priority information has been configured for the measurement duration, the controller 120 may perform determination on the measurement duration for which the priority information has been configured. In a case where the controller 120 has determined that communication will be prioritized over measurement for the measurement duration, the controller 120 may perform control to perform communication for the measurement duration for which the priority information has been configured. As a result, the controller 120 can grasp a measurement duration on which determination is to be performed as to whether to prioritize communication, and can appropriately perform priority determination.

Note that the controller 120 performs control to measure radio quality for a measurement duration for which the priority information has not been configured so that the radio quality can be measured. Therefore, for example, by not configuring the priority information for a measurement duration of the radio quality of a cell with high priority, control can be performed to prioritize communication with the base station 200 for a measurement duration with low priority while performing measurement for a measurement duration with high priority.

Furthermore, in a case where the controller 120 has determined that communication will be prioritized over measurement for a measurement duration and in a case where SR has been triggered, the controller 120 may perform control to perform SR transmission even for the measurement duration. This enables the UE 100 to perform SR transmission without delay after the SR has been triggered. As a result, even in the case of XR data having very severe delay requirements, the network 10 can schedule the XR data in a timely manner.

### (2-2) Second Priority Determination

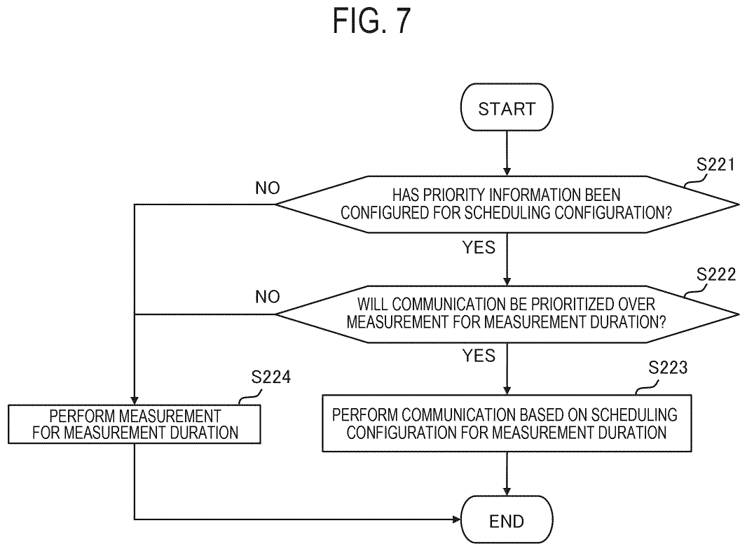

Second priority determination will be described with reference to FIG. 7. In the second priority determination, the controller 120 of the UE 100 determines whether the priority information has been configured for a scheduling configuration. Note that an already provided description is omitted in some cases.

### Step S221

The controller 120 determines whether the priority information has been configured for the scheduling configuration. In a case where the priority information has been configured for the scheduling configuration, the controller 120 performs the process of step S222. On the other hand, in a case where the priority information has not been configured for the scheduling configuration, the controller 120 performs the process of step S224.

For example, in a case where the priority information is included in configuration information for allocating a radio resource for communication in advance, the controller 120 may determine that the priority information has been configured for the scheduling configuration. The configuration information may be, for example, at least either SPS configuration information (for example, SPS-Config) used to configure downlink semi-persistent transmission or configured grant configuration information (for example, ConfiguredGrantConfig) used to configure uplink transmission without dynamic grant. Therefore, the scheduling configuration may be at least either an SPS configuration or a CG configuration.

The priority information may be configured in common to all (or some) of the scheduling configurations configured for the UE 100. The priority information may be dedicatedly configured for each of the scheduling configurations. Therefore, the priority information may be configured for a specified scheduling configuration. Therefore, from among a plurality of scheduling configurations configured for the UE 100, the priority information may be configured for a specified measurement scheduling configuration, and the priority information may not be configured for the remaining scheduling configurations. For example, information for configuring a specified scheduling configuration and the priority information may be associated with each other. The controller 120 may perform the process of step S222 on the specified scheduling configuration. The controller 120 may perform the process of step S224 on a scheduling configuration other than the specified scheduling configuration.

### Step S222

The controller 120 performs priority determination on the scheduling configuration for which the priority information has been configured. The controller 120 determines whether to prioritize communication with the base station 200 over measurement for a measurement duration. In a case where the controller 120 has determined that communication with the base station 200 will be prioritized over measurement for the measurement duration, the controller 120 performs the process of step S223. On the other hand, in a case where the controller 120 has determined that communication with the base station 200 will not be prioritized over measurement for the measurement duration, that is, in a case where the controller 120 has determined that measurement will be prioritized over communication with the base station 200 for the measurement duration, the controller 120 performs the process of step S224.

In a case where the priority information has also been configured for a measurement duration, the controller 120 may determine whether to prioritize communication with the base station 200 over measurement for the measurement duration, on the basis of the priority of priority information configured for the measurement duration (hereinafter, first priority information) and the priority of priority information configured for the scheduling configuration (hereinafter, second priority information). In a case where the priority of the second priority information is higher than the priority of the first priority information, the controller 120 may determine that communication with the base station 200 will be prioritized. In a case where the priority of the first priority information is higher than the priority of the second priority information, the controller 120 may determine that measurement will be prioritized. In a case where the priority of the second priority information is the same as the priority of the first priority information, the controller 120 may determine, for example, that measurement will be prioritized.

### Step S223 (Corresponding to Step 130)

The controller 120 performs control to perform communication based on the scheduling configuration for which the priority information has been configured, for the measurement duration. The controller 120 performs control to perform communication using a radio resource allocated in the scheduling configuration for which the priority information has been configured, for the measurement duration. Communication may be, for example, at least either decoding of PDSCH or transmission of PUSCH.

The controller 120 performs decoding of the PDSCH, for example, for a duration that corresponds to a time resource allocated on the basis of an SPS configuration for which the priority information has been configured within the measurement duration. The controller 120 also performs transmission of the PUSCH, for example, for a duration that corresponds to a time resource allocated on the basis of a CG configuration for which the priority information has been configured within the measurement duration. The controller 120 may perform measurement for a duration other than the duration that corresponds to the time resource allocated on the basis of the SPS configuration and/or the CG configuration for which the priority information has been configured within the measurement duration. Alternatively, the controller 120 may not perform measurement even for the measurement duration.

### Step S224 (Corresponding to Step 140)

The controller 120 performs control to measure radio quality without performing communication based on the scheduling configuration for which the priority information has not been configured, for the measurement duration.

As described above, in a case where the priority information has been configured for the scheduling configuration, the controller 120 may perform determination on the scheduling configuration for which the priority information has been configured. In a case where the controller 120 has determined that communication will be prioritized over measurement for a measurement duration, the controller 120 may perform control to perform communication using a radio resource allocated in the scheduling configuration for which the priority information has been configured, for the measurement duration. As a result, the controller 120 can appropriately determine whether to prioritize communication using the radio resource allocated in the scheduling configuration, and can appropriately perform priority determination.

Note that, for example, control is performed to perform measurement even if communication not based on the scheduling configuration has occurred for the measurement duration, and this makes it possible to prevent a significant decrease in the number of times of performing measurement for the measurement duration.

### (2-3) Third Priority Determination

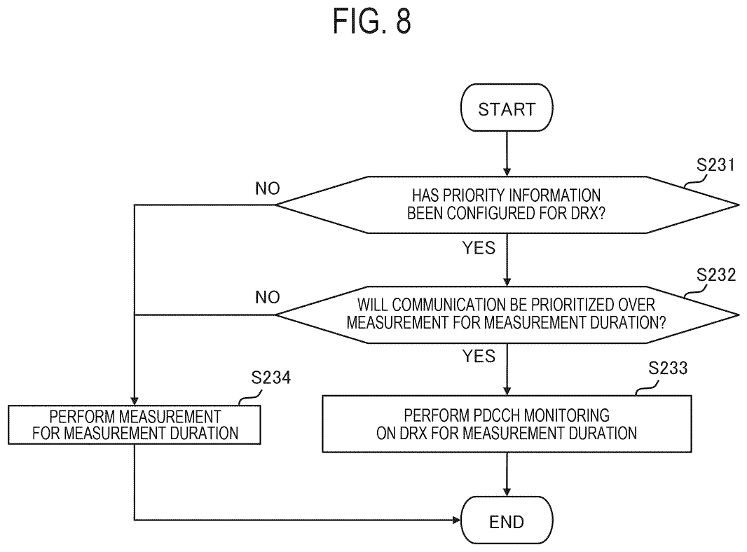

Third priority determination will be described with reference to FIG. 8. In the third priority determination, the controller 120 of the UE 100 determines whether the priority information has been configured for DRX. Note that an already provided description is omitted in some cases.

### Step S231

The controller 120 determines whether the priority information has been configured for DRX. In a case where the priority information has been configured for DRX, the controller 120 performs the process of step S232. On the other hand, in a case where the priority information has not been configured for DRX, the controller 120 performs the process of step S234.

For example, in a case where the priority information is included in configuration information for configuring DRX, the controller 120 may determine that the priority information has been configured for DRX. The configuration information may be, for example, DRX configuration information (for example, DRX-Config) used to configure a DRX-related parameter.

The priority information may be configured in common to all of the DRXs configured for the UE 100. The priority information may be dedicatedly configured for each of the DRXs. Therefore, the priority information may be configured for specified DRX. Therefore, from among a plurality of DRXs configured for the UE 100, the priority information may be configured for a specified DRX, and the priority information may not be configured for the remaining DRXs. For example, information for configuring a specified DRX and the priority information may be associated with each other. The controller 120 may perform the process of step S222 on the specified DRX. The controller 120 may perform the process of step S224 on DRX other than the specified DRX. Note that DRX may include, for example, short DRX and long DRX. The specified DRX may be short DRX or long DRX. Furthermore, DRX may include, for example, a secondary DRX group. The specified DRX may be the secondary DRX group. In this case, the priority information may be included in information (for example, DRX-ConfigSecondaryGroup) used to configure a DRX-related parameter for the secondary DRX group.

### Step S232

The controller 120 performs priority determination on DRX for which the priority information has been configured. The controller 120 determines whether to prioritize communication with the base station 200 over measurement for a measurement duration. In a case where the controller 120 has determined that communication with the base station 200 will be prioritized over measurement for the measurement duration, the controller 120 performs the process of step S233. On the other hand, in a case where the controller 120 has determined that communication with the base station 200 will not be prioritized over measurement for the measurement duration, that is, in a case where the controller 120 has determined that measurement will be prioritized over communication with the base station 200 for the measurement duration, the controller 120 performs the process of step S234.

In a case where the priority information has also been configured for the measurement duration, similarly to step S222, the controller 120 may determine whether to prioritize communication with the base station 200 over measurement for the measurement duration, on the basis of the priority of priority information configured for the measurement duration (that is, first priority information) and the priority of priority information configured for DRX (that is, second priority information).

### Step S233 (Corresponding to Step 130)

The controller 120 performs control to perform PDCCH monitoring on DRX for which the priority information has been configured, for the measurement duration. The controller 120 may perform control to decode PDCCH for a duration for which PDCCH monitoring is performed on DRX (for example, a duration for which the DRX configuration has instructed that PDCCH monitoring be performed) within the measurement duration. The duration for which the DRX configuration has instructed that PDCCH monitoring be performed may be a duration (for example, Active time) for which one or more timers relating to DRX are running, similarly to step S213.

The controller 120 may perform measurement for a duration other than the duration for which the DRX configuration has instructed that PDCCH monitoring be performed within the measurement duration. Alternatively, the controller 120 may not perform measurement even for the measurement duration.

Note that the transmitter 211 of the base station 200 may transmit, to the UE 100, sharing configuration information for sharing a duration for which PDCCH monitoring is performed on DRX and a measurement duration in a time division manner. The receiver 112 of the UE 100 may receive the sharing configuration information from the base station 200.

The sharing configuration information may indicate, for example, any of “Scheme 00”, “Scheme 01”, “Scheme 10”, and “Scheme 11”. “Scheme 00” may indicate, for example, that the time ratio of communication with the base station 200 (for example, PDCCH monitoring) (for example, the time ratio of Active time) is equal to the time ratio of measurement (the time ratio of the measurement duration). “Scheme 01” may indicate, for example, that an X value used to calculate a time ratio is 25%. “Scheme 10” may indicate, for example, that the X value used to calculate the time ratio is 50%. “Scheme 11” may indicate, for example, that the X value used to calculate the time ratio is 75%. The sharing configuration information may be, for example, measurement gap sharing configuration (MeasGapSharingConfig) that specifies a measurement gap sharing scheme.

The sharing configuration information may be configured for DRX for which the priority information has been configured. The sharing configuration information may be configured for a measurement duration for which the priority information has been configured. In addition, the sharing configuration information may be configured for each of the UEs or may be configured for each FR1/FR2.

The controller 120 may specify a designated duration on the basis of the sharing configuration information. The controller 120 may specify the designated duration, for example, by calculating the ratio of the designated duration to the measurement duration on the basis of the time ratio of communication with the base station 200 and the time ratio of measurement that have been specified by the sharing configuration information.

The controller 120 may perform control to perform PDCCH monitoring on DRX for a designated duration based on the sharing configuration information within the measurement duration. The controller 120 may perform control to perform measurement for a duration other than the designated duration within the measurement duration.

### Step S234 (Corresponding to Step 140)

The controller 120 performs control to measure radio quality without performing PDCCH monitoring on DRX for which the priority information has not been configured, for the measurement duration.

As described above, in a case where the priority information has been configured for DRX, the controller 120 may perform determination on DRX with which the priority information has been associated. In a case where the controller 120 has determined that communication will be prioritized over measurement for the measurement duration, the controller 120 may perform control to perform PDCCH monitoring on DRX for the measurement duration. As a result, the controller 120 can appropriately determine whether to prioritize PDCCH monitoring on DRX, and can appropriately perform priority determination.

In addition, the receiver 112 may receive, from the base station, sharing configuration information for sharing a duration for which PDCCH monitoring is performed on DRX and a measurement duration in a time division manner. The controller 120 may perform control to perform PDCCH monitoring on DRX for a designated duration based on the sharing configuration information within the measurement duration. As a result, even if PDCCH monitoring on DRX is prioritized for the measurement duration, the network 10 can flexibly configure the ratio of PDCCH monitoring on DRX to measurement.

Note that, for example, control is performed to perform measurement even if communication not based on DRX has occurred for the measurement duration, and this makes it possible to prevent a significant decrease in the number of times of performing measurement for the measurement duration.

### (2-4) Fourth Priority Determination

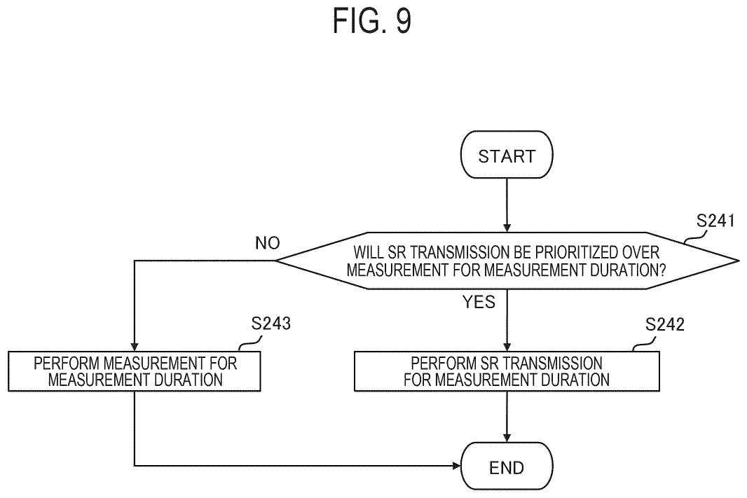

Fourth priority determination will be described with reference to FIG. 9. In the fourth priority determination, the priority information is information relating to whether to prioritize SR transmission over measurement. Note that an already provided description is omitted in some cases.

In a case where the receiver 112 of the UE 100 has received priority information relating to whether to prioritize SR transmission over measurement, the following determination can be performed.

### Step S241

The controller 120 determines whether to prioritize SR transmission over measurement for a measurement duration, on the basis of the priority information. In a case where the controller 120 has determined that SR transmission will be prioritized over measurement for the measurement duration, the controller 120 performs the process of step S242. On the other hand, in a case where the controller 120 has determined that communication with the base station 200 will not be prioritized over measurement for the measurement duration, that is, in a case where the controller 120 has determined that measurement will be prioritized over communication with the base station 200 for the measurement duration, the controller 120 performs the process of step S243.

In a case where the priority information has also been configured for the measurement duration, similarly to step S222, the controller 120 may determine whether to prioritize SR transmission over measurement for the measurement duration, on the basis of the priority of priority information configured for the measurement duration (that is, first priority information) and the priority of priority information relating to whether to prioritize SR transmission over measurement (this corresponds to second priority information).

### Step S242 (Corresponding to Step 130)

The controller 120 performs control to perform SR transmission for the measurement duration. The controller 120 may perform control to perform SR transmission for a duration that corresponds to a duration to which a radio resource has been allocated for SR transmission (for example, a time resource of a PUCCH resource/a time resource of a PUSCH resource) within the measurement duration.

The controller 120 may perform measurement for a duration other than the duration to which the radio resource has been allocated for SR transmission within the measurement duration. Alternatively, the controller 120 may not perform measurement even for the measurement duration.

### Step S243 (Corresponding to Step 140)

The controller 120 performs control to measure radio quality without performing SR transmission even if SR transmission has been triggered, for the measurement duration.

As described above, the receiver 112 may receive, from the base station 200, priority information relating to whether to prioritize SR transmission from the UE 100 to the base station 200 over measurement for the measurement duration. The controller 120 may determine whether to prioritize SR transmission over measurement for the measurement duration, on the basis of the priority information. As a result, the controller 120 can appropriately determine whether to prioritize SR transmission, and can appropriately perform priority determination. Furthermore, for example, in a case where the UE 100 has uplink data, the UE 100 can perform SR transmission even for the measurement duration. In a case where the UE 100 does not have the uplink data, the UE 100 can perform measurement for the measurement duration as usual.

### (2-5) Fifth Priority Determination

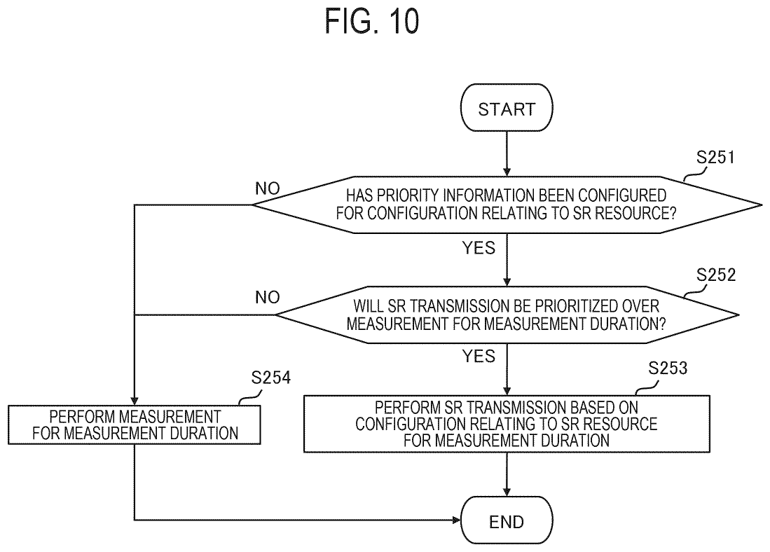

Fifth priority determination will be described with reference to FIG. 10. In the fifth priority determination, the controller 120 of the UE 100 determines whether the priority information has been configured for an SR-resource related configuration. Note that an already provided description is omitted in some cases.

### Step S251

The controller 120 determines whether the priority information has been configured for an SR-resource related configuration for allocating a radio resource for SR transmission in advance. In a case where the priority information has been configured for the SR-resource related configuration, the controller 120 performs the process of step S252. On the other hand, in a case where the priority information has not been configured for the SR-resource related configuration, the controller 120 performs the process of step S254.

For example, in a case where the priority information is included in configuration information for configuring relating to an SR resource for allocating a radio resource for SR transmission in advance, the controller 120 may determine that the priority information has been configured for the SR-resource related configuration. The configuration information may be, for example, at least either a scheduling request configuration (for example, SchedulingRequestConfig) used to configure a parameter for a dedicated scheduling request (SR) (D-SR) resource or a scheduling request resource configuration (for example, SchedulingRequestResourceConfig) for determining a physical layer resource on a PUCCH on which the UE 100 transmits a dedicated SR.

The priority information may be configured in common to all of the SR-resource related configurations for the UE 100. The priority information may be dedicatedly configured for each of the SR-resource related configurations. Therefore, the priority information may be configured for a specified SR-resource related configuration. Therefore, from among a plurality of SR-resource related configurations for the UE 100, the priority information may be configured for a specified SR-resource related configuration, and the priority information may not be configured for the remaining SR-resource related configurations. For example, specified SR-resource related configuration information and the priority information may be associated with each other. The controller 120 may perform the process of step S252 on the specified SR-resource related configuration (for example, the scheduling request configuration). The controller 120 may perform the process of step S254 on an SR-resource related configuration (for example, the scheduling request resource configuration) other than the specified SR-resource related configuration.

### Step S252

The controller 120 performs priority determination on an SR-resource related configuration for which the priority information has been configured. The controller 120 determines whether to prioritize SR transmission over measurement for a measurement duration. In a case where the controller 120 has determined that SR transmission will be prioritized over measurement for the measurement duration, the controller 120 performs the process of step S253. On the other hand, in a case where the controller 120 has determined that SR transmission will not be prioritized over measurement for the measurement duration, that is, in a case where the controller 120 has determined that measurement will be prioritized over SR transmission for the measurement duration, the controller 120 performs the process of step S254.

In a case where the priority information has also been configured for the measurement duration, similarly to step S222, the controller 120 may determine whether to prioritize SR transmission over measurement for the measurement duration, on the basis of the priority of priority information configured for the measurement duration (that is, first priority information) and the priority of priority information configured for the SR-resource related configuration (this corresponds to second priority information).

### Step S253 (Corresponding to Step 130)

The controller 120 performs control to perform SR transmission based on the SR-resource related configuration for which the priority information has been configured, for the measurement duration. The controller 120 performs control to perform SR transmission using a radio resource allocated in the SR-resource related configuration, for the measurement duration. For example, in a case where an SR has been triggered by a logical channel (for the measurement duration), the controller 120 performs control to perform SR transmission for the measurement duration.

The controller 120 performs SR transmission, for example, for a duration that corresponds to a time resource allocated in advance on the basis of the SR-resource related configuration for which the priority information has been configured within the measurement duration. The controller 120 may perform measurement for a duration other than the duration that corresponds to the time resource allocated on the basis of the SR-resource related configuration for which the priority information has been configured within the measurement duration. Alternatively, the controller 120 may not perform measurement even for the measurement duration.

### Step S254 (Corresponding to Step 140)

The controller 120 performs control to measure radio quality without performing SR transmission based on the SR-resource related configuration for which the priority information has not been configured, for the measurement duration.

As described above, the priority information may be configured for the SR-resource related configuration for allocating a radio resource for SR transmission in advance. In a case where the controller 120 has determined that SR transmission will be prioritized over measurement for the measurement duration, the controller 120 performs control to perform SR transmission using a radio resource allocated in the SR-resource related configuration, for the measurement duration. As a result, the controller 120 can appropriately determine which SR transmission is to be prioritized over measurement, and can appropriately perform priority determination. In addition, for example, by configuring the priority information for an SR-resource related configuration for XR data, the base station 200 can schedule the XR data in a timely manner.

### (2-6) Sixth Priority Determination

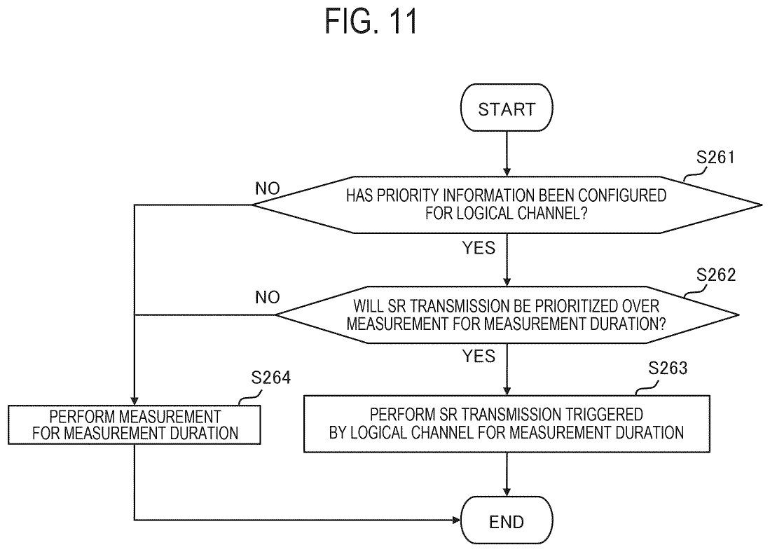

Sixth priority determination will be described with reference to FIG. 11. In the sixth priority determination, the controller 120 of the UE 100 determines whether the priority information has been configured for a logical channel. Note that an already provided description is omitted in some cases.

### Step S261

The controller 120 determines whether the priority information has been configured for a logical channel. In a case where the priority information has been configured for the logical channel, the controller 120 performs the process of step S262. On the other hand, in a case where the priority information has not been configured for the logical channel, the controller 120 performs the process of step S264.

For example, in a case where the priority information is included in configuration information for configuring a logical channel, the controller 120 may determine that the priority information has been configured for the logical channel. The configuration information may be, for example, a logical channel configuration (for example, LogicalChannelConfig) used to configure a logical channel parameter.

The priority information may be configured in common to all of the logical channels configured for the UE 100. The priority information may be dedicatedly configured for each of the logical channels. Therefore, the priority information may be configured for a specified logical channel. Therefore, from among a plurality of logical channels configured for the UE 100, the priority information may be configured for a specified logical channel, and the priority information may not be configured for the remaining logical channels. For example, the specified logical channel and the priority information may be associated with each other. The controller 120 may perform the process of step S262 on the specified logical channel. The controller 120 may perform the process of step S264 on a logical channel other than the specified logical channel.

### Step S262

The controller 120 performs priority determination on a logical channel for which the priority information has been configured. The controller 120 determines whether to prioritize SR transmission over measurement for a measurement duration, similarly to step S252. In a case where the controller 120 has determined that SR transmission will be prioritized over measurement for the measurement duration, the controller 120 performs the process of step S263. On the other hand, in a case where the controller 120 has determined that measurement will be prioritized over SR transmission for the measurement duration, the controller 120 performs the process of step S264.

In a case where the priority information has also been configured for the measurement duration, similarly to step S222, the controller 120 may determine whether to prioritize SR transmission over measurement for the measurement duration, on the basis of the priority of priority information configured for the measurement duration (that is, first priority information) and the priority of priority information configured for the logical channel (this corresponds to second priority information).

### Step S263 (Corresponding to Step 130)

The controller 120 performs control to perform SR transmission triggered by the logical channel for which the priority information has been configured, for the measurement duration. The controller 120 performs SR transmission triggered by the logical channel for which the priority information has been configured, for example, for a duration that corresponds to a time resource allocated (in advance) for SR transmission within the measurement duration. The controller 120 may perform measurement for a duration other than the duration that corresponds to the time resource allocated on the basis of the SR-resource related configuration within the measurement duration. Alternatively, the controller 120 may not perform measurement even for the measurement duration.

### Step S264 (Corresponding to Step 140):

The controller 120 performs control to measure radio quality without performing SR transmission based on the SR-resource related configuration for which the priority information has not been configured, for the measurement duration.

As described above, the priority information may be configured for a logical channel. In a case where the controller 120 has determined for the logical channel that communication will be prioritized over measurement for a measurement duration, the controller 120 may perform control to perform SR transmission triggered by the logical channel for the measurement duration. As a result, the controller 120 can appropriately determine which SR transmission is to be prioritized over measurement, and can appropriately perform priority determination. In addition, for example, by configuring the priority information for a logical channel configured for XR data, the base station 200 can schedule the XR data in a timely manner.

### Second Operation Example

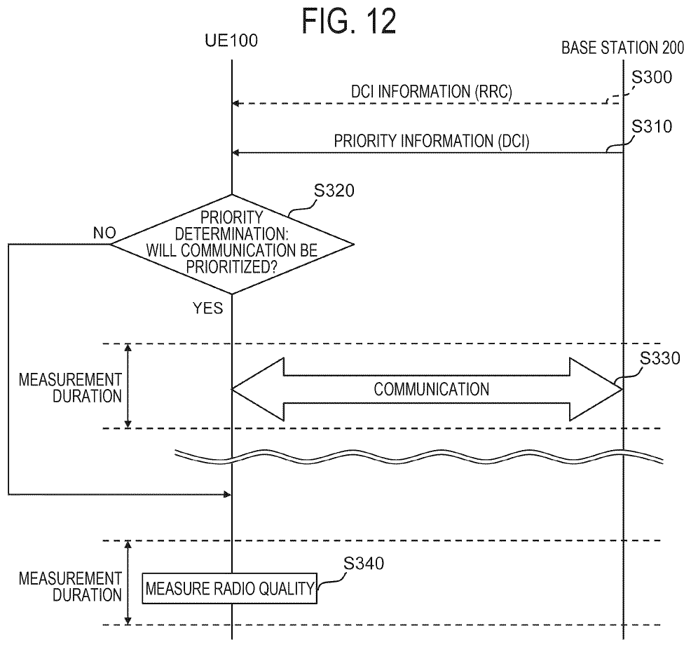

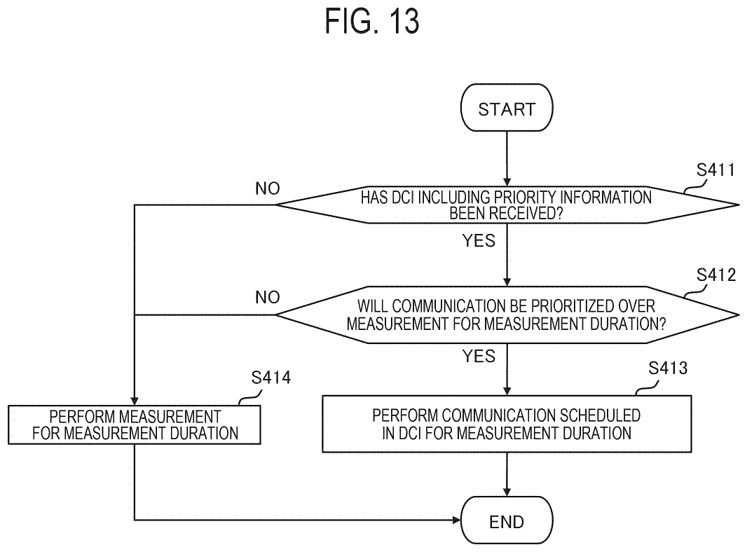

A second operation example will be described with reference to FIGS. 12 and 13. An already provided description is omitted in some cases. In the second operation example, the priority information is transmitted from the base station 200 to the UE 100 by using DCI.

### (b1) Outline of Second Operation Example

### Step S300

The transmitter 211 of the base station 200 may transmit information indicating DCI including the priority information (hereinafter, DCI information) to the UE 100 by using an RRC message. The receiver 112 of the UE 100 may receive the DCI information from the base station 200 by using the RRC message.

The DCI information may indicate whether the priority information is included in DCI received after the RRC message. The DCI information may be information indicating a type (a DCI format) of DCI including (or not including) the priority information. For example, the DCI information may indicate at least any of DCI format 0_1, DCI format 0_2, DCI format 1_1, and DCI format 1_2 as the type of the DCI including (or not including) the priority information. Stated another way, the DCI information may indicate whether the priority information is included in each DCI (each DCI format). Therefore, whether the priority information is included may be configured for each of the DCI formats. Alternatively, the DCI information may indicate whether the priority information is included in all of the DCI formats. Therefore, whether the priority information is included in the DCI format may be configured in common.

The controller 230 of the base station 200 may include the priority information in specified DCI (for example, DCI format 0_1/0_2 and/or 1_1/1_2). The controller 230 may include the priority information in DCI indicated by the DCI information as DCI including the priority information.

### Step S310

The transmitter 211 of the base station 200 transmits the DCI including the priority information to the UE 100. The receiver 112 of the UE 100 receives, from the base station 200, the DCI including the priority information.

In a case where specified DCI has been received, the controller 120 of the UE 100 may determine that the priority information is included in the DCI. Alternatively, in a case where DCI indicated by the DCI information as the DCI including the priority information has been received, the controller 120 may determine that the priority information is included in the DCI.

### Step S320

The controller 120 of the UE 100 performs priority determination on the basis of the priority information. The controller 230 may perform priority determination similarly to the first operation example described above. Therefore, the controller 120 can perform priority determination on an object for which the priority information has been configured. In addition, similarly to the above, in a case where the priority information has been configured for the measurement duration and another object other than the measurement duration (for example, at least any of a scheduling configuration, DRX, SR transmission, an SR-resource related configuration, and a logical channel), the controller 120 may perform priority determination on the basis of the priority indicated by the priority information. The controller 120 may determine, for example, that an operation relating to an object for which priority information with high priority has been configured will be prioritized.

Furthermore, the controller 120 may determine that an object for which the priority information included in the DCI has been configured (for example, another object other than the measurement duration; communication scheduled by the DCI to be described later, or the like) will be prioritized over an object for which the priority information included in the RRC message has been configured (for example, the measurement duration). Furthermore, the controller 230 may perform the priority determination described later.

### Steps S330 and S340

These steps are similar to steps S130 and S140.

### (b2) Priority Determination

An example of priority determination in the present operation example will be described with reference to FIG. 13.

### Step S411

The controller 120 of the UE 100 determines whether DCI including the priority information has been received. In a case where the DCI including the priority information has been received, the controller 120 performs the process of step S412. On the other hand, in a case where DCI not including the priority information has been received, the controller 120 performs the process of step S414.

### Step S412

The controller 120 performs priority determination on communication scheduled by the DCI. The controller 120 determines whether communication scheduled by the DCI will be prioritized over measurement for a measurement duration. In a case where the controller 120 has determined that communication scheduled by the DCI will be prioritized over measurement for the measurement duration, the controller 120 performs the process of step S413. On the other hand, in a case where the controller 120 has determined that communication scheduled by the DCI will not be prioritized over measurement for the measurement duration, that is, in a case where the controller 120 has determined that measurement will be prioritized over communication scheduled by the DCI for the measurement duration, the controller 120 performs the process of step S414.

### Step S413 (Corresponding to Step 130)

The controller 120 performs control to perform communication scheduled by the DCI including the priority information for the measurement duration. The controller 120 performs control to perform communication scheduled by the DCI including the priority information for the measurement duration. Communication may be, for example, at least either decoding of PDSCH or transmission of PUSCH.

The controller 120 performs transmission of the PUSCH, for example, for a duration that corresponds to a time resource allocated by the DCI including the priority information within the measurement duration. The controller 120 also performs decoding of the PDSCH, for example, for a duration that corresponds to a time resource allocated by the DCI including the priority information within the measurement duration. The controller 120 may perform measurement for a duration other than the duration that corresponds to the time resource allocated by the DCI including the priority information within the measurement duration. Alternatively, the controller 120 may not perform measurement even for the measurement duration.

### Step S414 (Corresponding to Step 140)

The controller 120 performs control to measure radio quality without performing communication scheduled by the DCI not including the priority information, for the measurement duration.

As described above, the receiver 112 of the UE 100 receives, from the base station 200, DCI including priority information relating to whether to prioritize communication between the UE 100 and the base station 200 for a measurement duration. The controller 120 determines whether to prioritize communication over measurement for the measurement duration, on the basis of the priority information. Therefore, the network 10 can dynamically notify the UE 100 of the priority information in comparison with a case where the priority information is transmitted by using the RRC message. The network 10 can easily schedule XR data in a timely manner, by transmitting the DCI including the priority information, for example, in a case where the traffic of the XR data arrives within the measurement duration. As a result, communication capacity can be prevented from decreasing.

Furthermore, the controller 120 may determine whether to prioritize communication scheduled by the DCI over measurement for the measurement duration, on the basis of the priority information. Therefore, for example, even in a case where communication data has suddenly been generated for the measurement duration, the base station 200 can exchange the communication data even for the measurement duration by scheduling a radio resource for the communication data by using the DCI including the priority information. As a result, communication capacity can be prevented from decreasing.

Furthermore, the receiver 112 of the UE 100 may receive, from the base station 200, information indicating the DCI including the priority information, by using the RRC message. As a result, the UE 100 can grasp whether the received DCI includes the priority information, and can appropriately perform priority determination.

### Other Embodiments

In the embodiment described above, description has been provided by using, as an example, a case where the priority information is configured for the measurement duration, but this is not restrictive. The priority information may be configured for, for example, at least any of a measurement object (for example, MeasObject), a radio signal to be measured (for example, SSB, CSI-RS, or the like), a measurement report, and measurement itself. Therefore, the measurement duration described above may be replaced with at least any of the measurement object (for example, MeasObject), the radio signal to be measured (for example, SSB, CSI-RS, or the like), the measurement report, and the measurement. The priority information may be associated with, for example, at least any of a measurement identifier (for example, MeasId) used to identify a measurement configuration, a measurement object identifier (for example, MeasObjectId) used to identify a measurement object configuration, and a report configuration identifier (for example, ReportConfigId) used to identify a measurement report configuration. The priority information may be included in a list (for example, MeasIdToAddModList) relating to a list of measurement identifiers to be added or modified.

In the embodiment described above, as a case where the priority information is configured for a designated object (for example, the measurement duration), it has been described that the priority information is configured for the designated object, in a case where the priority information is included in configuration information for configuring the designated object (for example, measurement configuration information (for example, MeasConfig)). However, this is not restrictive. The priority information may be configured for the designated object by associating the priority information with the designated object. For example, the priority information may be configured for the designated object by associating the priority information with the designated object by using a designated identifier.

In the embodiment described above, description has been provided by using, as an example, a case where the priority information is transmitted to the UE 100 by using an RRC message or DCI, but this is not restrictive. The transmitter 211 of the base station 200 may transmit, for example, a medium access control control element (MAC CE) including the priority information to the UE 100. The receiver 112 of the UE 100 may receive the MAC CE including the priority information from the base station 200.

In the embodiment described above, the mobile communication system 1 has been described by using, as an example, the mobile communication system based on the NR. However, the mobile communication system 1 is not limited to this example. The mobile communication system 1 may be a system conforming to the TS of either long term evolution (LTE) or another generation system (for example, the sixth generation) of the 3GPP standard. The base station 200 may be an eNB that provides protocol terminations of E-UTRA user plane and control plane toward the UE 100 in LTE. The mobile communication system 1 may be a system conforming to the TS of a standard other than the 3GPP standard. The base station 200 may be an integrated access and backhaul (IAB) donor or an IAB node.

In the embodiment described above, the mobile communication system 1 has been described by using, as an example, the mobile communication system based on the NR. However, the mobile communication system 1 is not limited to this example. The mobile communication system 1 may be a system conforming to the TS of either LTE or another generation system (for example, the sixth generation) of the 3GPP standard. The base station 200 may be an eNB that provides protocol terminations of E-UTRA user plane and control plane toward the UE 100 in LTE. The mobile communication system 1 may be a system conforming to the TS of a standard other than the 3GPP standard.

The steps in the operation of the embodiment described above do not necessarily have to be performed in time series according to the order described in the flowchart or the sequence diagram. For example, the steps in the operation may be performed in an order different from the order described in the flowchart or the sequence diagram, or may be performed in parallel. In addition, some of the steps in the operation may be eliminated, or additional steps may be added to the processing. Moreover, each operation flow described above is not necessarily implemented separately and independently, and two or more operation flows can be implemented in combination. For example, some of the steps of one operation flow may be added to another operation flow, or some of the steps of one operation flow may be replaced with some of the steps of another operation flow.

A program for causing a computer to perform each processing performed by the UE 100 or the base station 200 may be provided. The program may be recorded in a computer-readable medium. The use of the computer-readable medium enables the program to be installed in the computer. Here, the computer-readable medium in which the program has been recorded may be a non-transitory recording medium. The non-transitory recording medium is not particularly limited, and may be, for example, a recording medium such as a compact disk read only memory (CD-ROM) or a digital versatile disc read only memory (DVD-ROM). Furthermore, a circuit that performs each processing to be performed by the UE 100 or the base station 200 may be integrated, and at least part of the UE 100 or the base station 200 may be configured as a semiconductor integrated circuit (a chipset or a system on chip (SoC)).

In the embodiment described above, the term “transmit” may mean performing processing of at least one layer in a protocol stack used for transmission, or may mean physically transmitting a signal in a wireless or wired manner. Alternatively, the term “transmit” may mean a combination of performing processing of at least one layer and physically transmitting a signal in a wireless or wired manner that have been described above. Similarly, the term “receive” may mean performing processing of at least one layer in a protocol stack used for reception, or may mean physically receiving a signal in a wireless or wired manner. Alternatively, the term “receive” may mean a combination of performing processing of at least one layer and physically receiving a signal in a wireless or wired manner that have been described above. Similarly, the term “obtain/acquire” may mean obtaining/acquiring information from stored information, may mean obtaining/acquiring information from information received from another node, or may mean obtaining/acquiring information by generating the information. Similarly, the phrases “based on” and “depending on/in response to” do not mean “based only on” or “depending only on/in response only to”, unless otherwise stated. The phrase “based on” means both “based only on” and “at least partially based on”. Similarly, the phrase “depending on/in response to” means both “depending only on/in response only to” and “at least partially depending on/at least partially in response to”. Similarly, the terms “include” and “comprise” do not mean only including enumerated items, but mean “may only include enumerated items or may include additional items in addition to the enumerated items”. Similarly, in the present disclosure, the term “or” does not mean exclusive OR, but means OR. Moreover, no references to elements using designations such as “first” or “second” used in the present disclosure generally limit the amounts or orders of the elements. Such designations can be used in the present disclosure as a convenient method of distinguishing between two or more elements. Therefore, references to first and second elements do not mean that only two elements can be employed therein or that the first element should precede the second element in any form. In the present disclosure, in a case where articles such as “a”, “an”, and “the” in English are added by translation, such articles cover the plural meaning unless the context clearly indicates otherwise.

Although the present disclosure has been described according to examples, it is understood that the present disclosure is not limited to the examples or structures. The present disclosure also includes various modified examples or modifications made within an equivalent range. In addition, various combinations or modes, and other combinations or modes including only one element, more elements, or less elements also fall within the scope and spirit of the present disclosure.

### SUPPLEMENTARY NOTES

Features related to the above-described embodiments are additionally described.

### Supplementary Note 1

A communication apparatus, comprising:
a receiver configured to receive, from a base station, priority information relating to whether to prioritize communication between the communication apparatus and the base station for a measurement duration that is a duration for which radio quality is measured; and
a controller configured to perform determination as to whether to prioritize the communication over measurement for the measurement duration, based on the priority information, wherein
the priority information is configured for at least any of the measurement duration, a scheduling configuration for allocating a radio resource for the communication in advance, and discontinuous reception (DRX), and
the controller is configured to perform the determination on an object for which the priority information has been configured.

### Supplementary Note 2

The communication apparatus according to supplementary note 1, wherein
in a case where the priority information has been configured for the measurement duration, the controller is configured to perform the determination on the measurement duration for which the priority information has been configured, and
in a case where the controller has determined that the communication will be prioritized over the measurement for the measurement duration, the controller is configured to perform control to perform the communication for the measurement duration for which the priority information has been configured.

### Supplementary Note 3

The communication apparatus according to supplementary note 2, wherein
in a case where the controller has determined that the communication will be prioritized over the measurement for the measurement duration and in a case where a scheduling request (SR) has been triggered, the controller is configured to perform control to transmit the SR even for the measurement duration.

### Supplementary Note 4

The communication apparatus according to any one of supplementary notes 1 to 3, wherein
in a case where the priority information has been configured for the scheduling configuration, the controller is configured to perform the determination on the scheduling configuration for which the priority information has been configured, and
in a case where the controller has determined that the communication will be prioritized over the measurement for the measurement duration, the controller is configured to perform control to perform the communication using the radio resource allocated in the scheduling configuration for which the priority information has been configured, for the measurement duration.

### Supplementary Note 5

The communication apparatus according to any one of supplementary notes 1 to 4, wherein
in a case where the priority information has been configured for the DRX, the controller is configured to perform the determination on the DRX with which the priority information has been associated, and
in a case where the controller has determined that the communication will be prioritized over the measurement for the measurement duration, the controller is configured to perform control to perform physical downlink control channel (PDCCH) monitoring in the DRX, for the measurement duration.

### Supplementary Note 6

The communication apparatus according to supplementary note 5, wherein
the receiver is configured to receive, from the base station, sharing configuration information for sharing a duration for which the PDCCH monitoring in the DRX is performed and the measurement duration in a time division manner, and
the controller is configured to perform control to perform the PDCCH monitoring in the DRX for a designated duration based on the sharing configuration information within the measurement duration.

### Supplementary Note 7

A communication apparatus, comprising:
a receiver configured to receive, from a base station, priority information relating to whether to prioritize scheduling request (SR) transmission from the communication apparatus to the base station over measurement for a measurement duration that is a duration for which radio quality is measured; and
a controller configured to perform determination as to whether to prioritize the SR transmission over the measurement for the measurement duration, based on the priority information.

### Supplementary Note 8

The communication apparatus according to supplementary note 7, wherein
the priority information is configured for an SR-resource related configuration for allocating a radio resource for the SR transmission in advance, and
in a case where the controller has determined that the SR transmission will be prioritized over the measurement for the measurement duration, the controller is configured to perform control to perform the SR transmission using the radio resource allocated in the SR-resource related configuration, for the measurement duration.

### Supplementary Note 9

The communication apparatus according to supplementary note 7 or 8, wherein
the priority information is configured for a logical channel, and
in a case where the controller has determined for the logical channel that the communication will be prioritized over the measurement for the measurement duration, the controller is configured to perform control to perform the SR transmission triggered by the logical channel, for the measurement duration.

### Supplementary Note 10

A communication apparatus, comprising:
a receiver configured to receive, from a base station, downlink control information (DCI) including priority information relating to whether to prioritize communication between the communication apparatus and the base station for a measurement duration that is a duration for which radio quality is measured; and
a controller configured to perform determination as to whether to prioritize the communication over measurement for the measurement duration, based on the priority information.

### Supplementary Note 11

The communication apparatus according to supplementary note 10, wherein
the controller is configured to perform determination as to whether to prioritize the communication scheduled by the DCI over the measurement for the measurement duration, on the basis of the priority information.

### Supplementary Note 12

The communication apparatus according to supplementary note 10 or 11, wherein
the receiver is configured to receive, from the base station, information indicating the DCI including the priority information, by using a radio resource control (RRC) message.

### Supplementary Note 13

A communication method performed by a communication apparatus, the communication method comprising the steps of:
receiving, from a base station, priority information relating to whether to prioritize communication between the communication apparatus and the base station for a measurement duration that is a duration for which radio quality is measured; and
performing determination as to whether to prioritize the communication over measurement for the measurement duration, based on the priority information, wherein
the priority information is configured for at least any of the measurement duration, a scheduling configuration for allocating a radio resource for the communication in advance, and discontinuous reception (DRX), and
in the performing the determination on the basis of the priority information, the determination is performed on an object for which the priority information has been configured.

### Supplementary Note 14

A communication method performed by a communication apparatus, the communication method comprising the steps of:
receiving, from a base station, priority information relating to whether to prioritize scheduling request (SR) transmission from the communication apparatus to the base station over measurement for a measurement duration that is a duration for which radio quality is measured; and
performing determination as to whether to prioritize the SR transmission over the measurement for the measurement duration, based on the priority information.

### Supplementary Note 15

A communication method performed by a communication apparatus, the communication method comprising the steps of:
receiving, from a base station, downlink control information (DCI) including priority information relating to whether to prioritize communication between the communication apparatus and the base station for a measurement duration that is a duration for which radio quality is measured; and
performing determination as to whether to prioritize the communication over measurement for the measurement duration, based on the priority information.

1. A communication apparatus, comprising:
a receiver configured to receive a radio resource control (RRC) message; and
a controller, wherein
the RRC message includes:
measurement gap configuration information including first information for configuring a duration of a measurement gap for measurement of radio quality;
information indicating that second information is included in downlink control information (DCI) format 1_1, the second information being for determining whether at least one of transmission and reception is enabled during the duration of the measurement gap; and
information indicating that the second information is included in DCI format 0_1, and
the controller is configured to:
determine, based on the information indicating that the second information is included in the DCI format 1_1 being included in the RRC message, which of the measurement of radio quality during the duration of the measurement gap and at least one of transmission and reception during the duration of the measurement gap is enabled, in accordance with the second information included in the DCI format 1_1; and
determine, based on the information indicating that the second information is included in the DCI format 0_1 being included in the RRC message, which of the measurement of radio quality during the duration of the measurement gap and at least one of transmission and reception during the duration of the measurement gap is enabled, in accordance with the second information included in the DCI format 0_1.

2. The communication apparatus according to claim 1, wherein
at least one of transmission and reception during the duration of the measurement gap includes at least one of monitoring a physical downlink control channel (PDCCH), decoding a physical downlink shared channel (PDSCH), transmitting a physical uplink shared channel (PUSCH), and transmitting a scheduling request (SR).

3. The communication apparatus according to claim 1, wherein
the controller is configured to:
in a case where the second information indicates a predetermined value, not perform the measurement of radio quality during the duration of the measurement gap; and
in a case where the second information indicates a value other than the predetermined value, perform the measurement of radio quality during the duration of the measurement gap.

4. The communication apparatus according to claim 1, wherein
the receiver is configured to receive the RRC message including information indicating that second information is included in DCI format 1_2, and
the controller is configured to determine, based on the information indicating that the second information is included in the DCI format 1_2 being included in the RRC message, which of the measurement of radio quality during the duration of the measurement gap and at least one of transmission and reception during the duration of the measurement gap is enabled, in accordance with the second information included in the DCI format 1_2.

5. The communication apparatus according to claim 1, wherein
the receiver is configured to receive the RRC message including information indicating that second information is included in DCI format 0_2, and
the controller is configured to determine, based on the information indicating that the second information is included in the DCI format 0_2 being included in the RRC message, which of the measurement of radio quality during the duration of the measurement gap and at least one of transmission and reception during the duration of the measurement gap is enabled, in accordance with the second information included in the DCI format 0_2.

6. A base station, comprising:
a transmitter configured to transmit a radio resource control (RRC) message to a communication apparatus, wherein
the RRC message includes:
measurement gap configuration information including first information for configuring a duration of a measurement gap for measurement of radio quality;
information indicating that second information is included in downlink control information (DCI) format 1_1, the second information used by the communication apparatus to determine whether at least one of transmission and reception is enabled during the duration of the measurement gap; and
information indicating that the second information is included in DCI format 0_1, and
the transmitter is configured to:
transmit, to the communication apparatus, the DCI format 1_1 including the second information based on transmitting the RRC message including the information indicating that the second information is included in the DCI format 1_1; and
transmit, to the communication apparatus, the DCI format 0_1 including the second information based on transmitting the RRC message including the information indicating that the second information is included in the DCI format 0_1.

7. The base station according to claim 6, wherein
at least one of transmission and reception during the duration of the measurement gap includes at least one of monitoring a physical downlink control channel (PDCCH), decoding a physical downlink shared channel (PDSCH), transmitting a physical uplink shared channel (PUSCH), and transmitting a scheduling request (SR).

8. The base station according to claim 6, wherein
the transmitter is configured to:
in a case where the measurement of radio quality during the duration of the measurement gap is not to be performed, transmit the DCI format 1_1 and the DCI format 0_1, each including the second information indicating a predetermined value; and
in a case where the measurement of radio quality during the duration of the measurement gap is to be performed, transmit the DCI format 1_1 and the DCI format 0_1, each including the second information indicating a value other than the predetermined value.

9. The base station according to claim 6, wherein
the transmitter is configured to:
transmit, to the communication apparatus, the RRC message including the information indicating that the second information is included in the DCI format 1_2; and
transmit, to the communication apparatus, the DCI format 1_2 including the second information based on transmitting the RRC message including the information indicating that the second information is included in the DCI format 1_2.

10. The base station according to claim 6, wherein
the transmitter is configured to:
transmit, to the communication apparatus, the RRC message including the information indicating that the second information is included in the DCI format 0_2; and
transmit, to the communication apparatus, the DCI format 0_2 including the second information based on transmitting the RRC message including the information indicating that the second information is included in the DCI format 0_2.

11. A communication method performed by a communication apparatus, the method comprising:
receiving a radio resource control (RRC) message including:
measurement gap configuration information including first information for configuring a duration of a measurement gap for measurement of radio quality;
information indicating that second information is included in downlink control information (DCI) format 1_1, the second information being for determining whether at least one of transmission and reception is enabled during the duration of the measurement gap; and
information indicating that the second information is included in DCI format 0_1, and
determining, based on the information indicating that the second information is included in the DCI format 1_1 being included in the RRC message, which of the measurement of radio quality during the duration of the measurement gap and at least one of transmission and reception during the duration of the measurement gap is enabled, in accordance with the second information included in the DCI format 1_1; and
determining, based on the information indicating that the second information is included in the DCI format 0_1 being included in the RRC message, which of the measurement of radio quality during the duration of the measurement gap and at least one of transmission and reception during the duration of the measurement gap is enabled, in accordance with the second information included in the DCI format 0_1.

12. The communication method according to claim 11, wherein
at least one of transmission and reception during the duration of the measurement gap includes at least one of monitoring a physical downlink control channel (PDCCH), decoding a physical downlink shared channel (PDSCH), transmitting a physical uplink shared channel (PUSCH), and transmitting a scheduling request (SR).

13. The communication method according to claim 11, comprising:
in a case where the second information indicates a predetermined value, not performing the measurement of radio quality during the duration of the measurement gap; and
in a case where the second information indicates a value other than the predetermined value, performing the measurement of radio quality during the duration of the measurement gap.

14. The communication method according to claim 11, comprising:
receiving the RRC message including information indicating that second information is included in DCI format 1_2; and
determining, based on the information indicating that the second information is included in the DCI format 1_2 being included in the RRC message, which of the measurement of radio quality during the duration of the measurement gap and at least one of transmission and reception during the duration of the measurement gap is enabled, in accordance with the second information included in the DCI format 1_2.

15. The communication method according to claim 11, comprising:
receiving the RRC message including information indicating that second information is included in DCI format 0_2; and
determining, based on the information indicating that the second information is included in the DCI format 0_2 being included in the RRC message, which of the measurement of radio quality during the duration of the measurement gap and at least one of transmission and reception during the duration of the measurement gap is enabled, in accordance with the second information included in the DCI format 0_2.
